(19) United States
(12) Patent Application Publication
(10) Pub. No.: US 2017/0254146 A1
(43) Pub. Date: Sep. 7, 2017

(54) MULTIPURPOSE LADDER ATTACHMENT

(71) Applicants: Donald H. Burchnell, Greeneville, TN (US); Donald J. Burchnell, Greeneville, TN (US); Joseph R. Burchnell, Greeneville, TN (US)

(72) Inventors: Donald H. Burchnell, Greeneville, TN (US); Donald J. Burchnell, Greeneville, TN (US); Joseph R. Burchnell, Greeneville, TN (US)

(21) Appl. No.: 15/451,559

(22) Filed: Mar. 7, 2017

Related U.S. Application Data
(60) Provisional application No. 62/304,502, filed on Mar. 7, 2016.

(51) Int. Cl. E06C 7/14; F16M 13/02

(52) U.S. Cl. CPC E06C 7/14; F16M 13/02

(57) ABSTRACT

A multipurpose ladder attachment comprises a bracket plate, a pair of U-bolts, and nuts for attaching the bracket plates to a ladder. Upper apertures in the bracket plate receive the threaded ends of the upper U-bolt, and lower apertures in the bracket plate receive the threaded ends of the lower U-bolt. At least two of these attachments are typically used in tandem on a ladder. Each bracket plate has a tapered slot extending downward from the upper edge that terminates in a hole. The holes in opposing bracket plates may be used to receive a pipe on which wire spools can be hung. The holes in opposing bracket plates can also be used for holding a piece of conduit as it is sawed. If the pipe to be sawed is too large to be received in the holes, it may be cradled in the tapered slots above the holes.

### RELATED APPLICATIONS

This application claims priority to provisional patent application Ser. No. 62/304,502, filed Mar. 7, 2016, titled “Multipurpose Ladder Attachment,” the entire contents of which is incorporated herein by reference.

### FIELD

This invention relates to construction tools. More particularly, this invention relates to a multi-purpose ladder attachment, such as for use by professional electricians on a job site.

### BACKGROUND

A commercial electrician needs to have spools of wire handy when standing on a ladder doing an electrical wiring installation. The electrician also need fixtures on the ladders for holding conduit and channel while it is being sawed. Although the prior art describes fixtures for holding multiple spools of wire on a ladder (such as U.S. Pat. No. 4,533,091), such fixtures are lacking in that they are awkward and dangerous, as they are typically mounted in locations on the ladder where they are in the electrician's way and are tripping hazards.

What is needed, therefore, is a more useful, safe and versatile ladder attachment for use by electricians.

### SUMMARY

The above and other needs are met by a multipurpose ladder attachment that attaches to the leg of a ladder. In a preferred embodiment, the multipurpose ladder attachment includes a bracket plate, upper and lower U-bolts, and upper and lower fasteners for attaching the U-bolts to the bracket plate. The bracket plate has an upper edge, a lower edge and a central region disposed between the upper and lower edges. The bracket plate includes a tapered slot that extends from the upper edge toward the central region. The tapered slot has a first width at the upper edge and a second width in the central region, wherein the first width is greater than the second width. A pair of upper apertures are disposed between the upper edge and the central region of the bracket plate, and a pair of lower apertures are disposed between the lower edge and the central region of the bracket plate. The pair of upper apertures are spaced apart from each other by a distance that is greater than the width of the leg of the ladder. The pair of lower apertures are also spaced apart from each other by a distance that is greater than the width of the leg of the ladder. The upper U-bolt has ends that pass through the pair of upper apertures, and the lower U-bolt has ends that pass through the pair of lower apertures. The upper fasteners attach to the ends of the upper U-bolt, and the lower fasteners attach to the ends of the lower U-bolt. The upper and lower U-bolts are operable to be disposed around the leg of the ladder, and the upper and lower fasteners are operable to tighten down against the bracket plate to pull the upper and lower U-bolts against the leg of the ladder, thereby securing the multipurpose ladder attachment to the ladder

In some embodiments, a spacer block is attached to the bracket plate between the pair of upper apertures and the pair of lower apertures. The spacer block is received within an interior portion of the leg of the ladder when the bracket plate is secured to the leg of the ladder.

In some embodiments, a circular hole is disposed in the central region of the bracket plate and connected to the tapered slot.

In another aspect, the invention provides a multipurpose ladder attachment system that attaches to a ladder. The multipurpose ladder attachment system includes at least two of the multipurpose ladder attachments described above that are attached in tandem to opposing legs of the ladder. In a preferred embodiment, the tapered slots in the bracket plates of the opposing multipurpose ladder attachments form a cradle in which a section of pipe or conduit may be supported, such as while it is being sawed to a desired length. Also in a preferred embodiment, the holes in the central region of the bracket plates of the opposing multipurpose ladder attachments are operable to receive a section of pipe or rod on which spools of wire may be supported on the ladder.

### BRIEF DESCRIPTION OF THE DRAWINGS

Other embodiments of the invention will become apparent by reference to the detailed description in conjunction with the figures, wherein elements are not to scale so as to more clearly show the details, wherein like reference numbers indicate like elements throughout the several views, and wherein:

FIGS. 1A, 1B, 1C and 1D depict a multipurpose ladder attachment according to a preferred embodiment;

FIGS. 2A, 2B, 2C and 2D depict a multipurpose ladder attachment attached to a ladder according to a preferred embodiment;

FIG. 3 depicts a bracket plate of a multipurpose ladder attachment according to a preferred embodiment;

FIG. 4 depicts multipurpose ladder attachments attached to a ladder according to a preferred embodiment;

FIG. 5 depicts multiple wire spools being supported by multipurpose ladder attachments attached to a ladder according to a preferred embodiment;

FIGS. 6 and 7 depict multipurpose ladder attachments attached to a ladder and supporting sections of conduit being sawed according to a preferred embodiment; and

FIG. 8 depicts a tool hanging from a multipurpose ladder attachment attached to a ladder according to a preferred embodiment.

### DETAILED DESCRIPTION

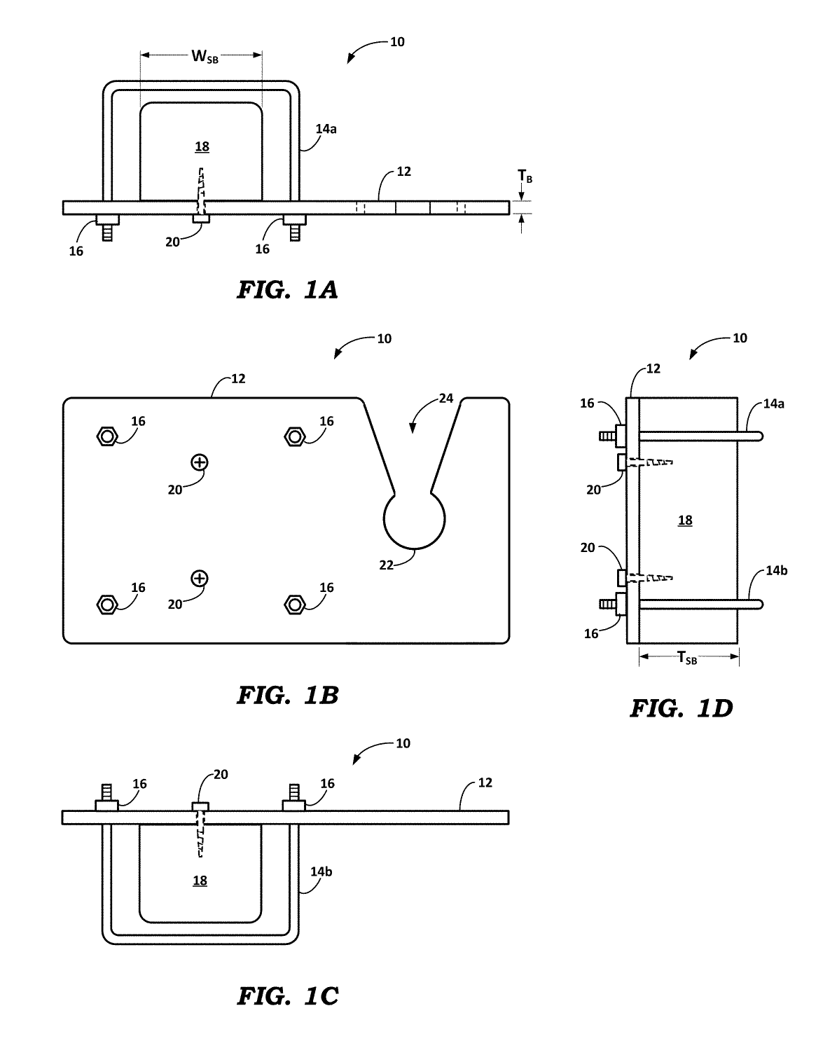

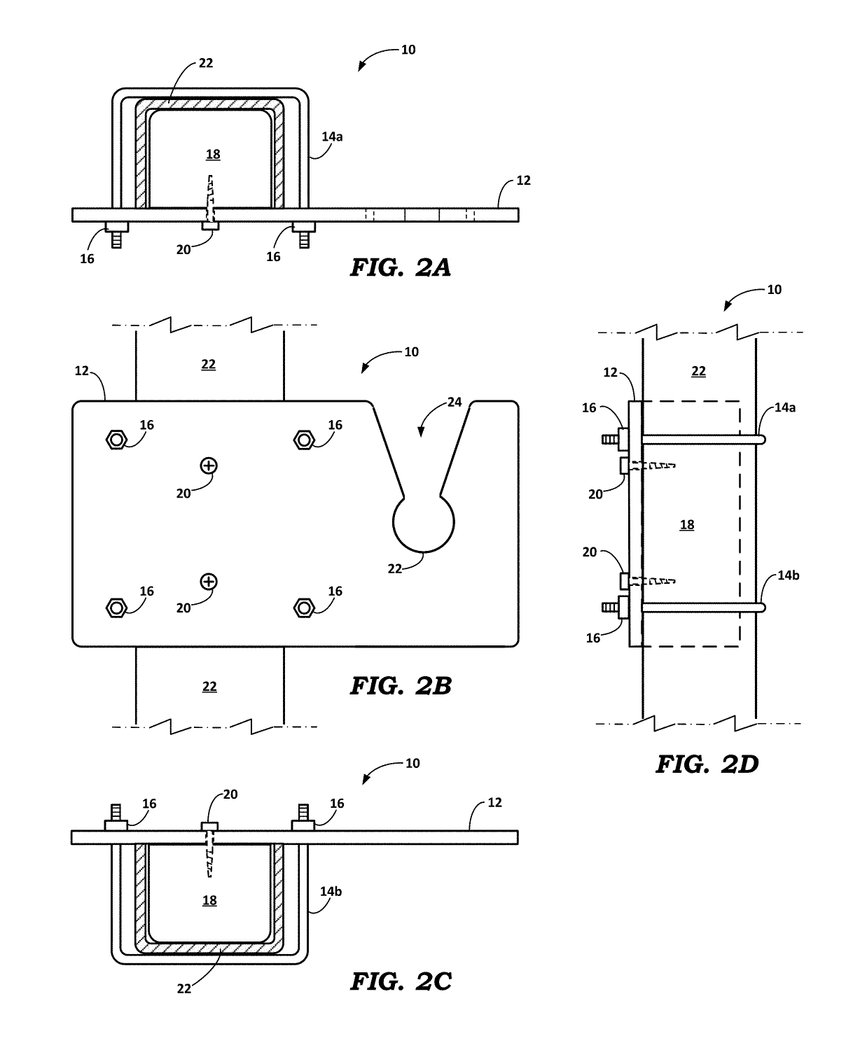

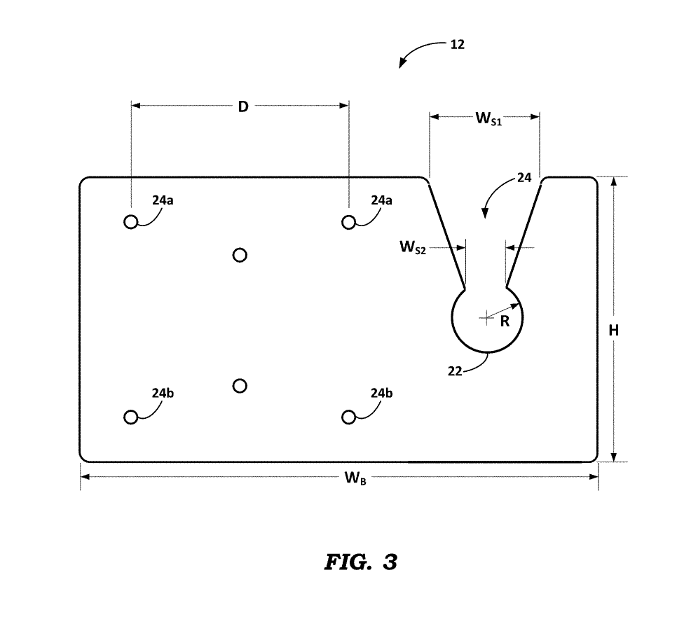

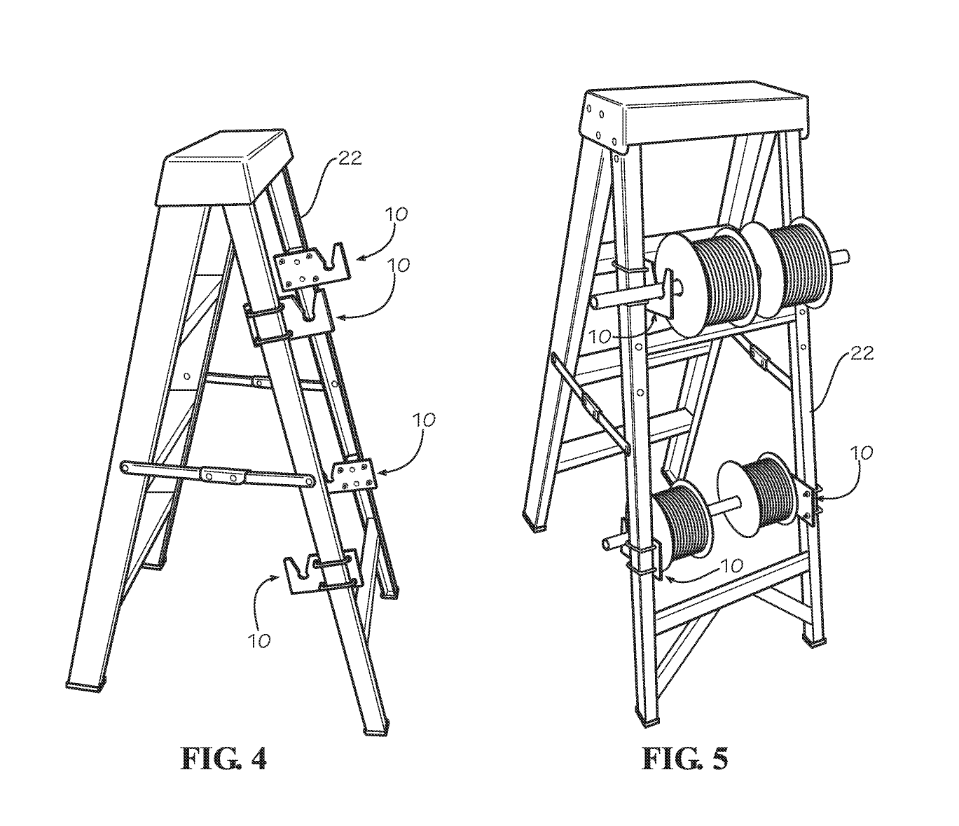

FIGS. 1A-1D, 2A-2D and 3 depict a preferred embodiment of a multipurpose ladder attachment 10. In a typical application, two of these attachments are used in tandem on a ladder as shown in FIGS. 4-8. Each attachment 10 comprises a bracket plate 12 and a pair of U-bolts 14a-14b and nuts 16 for attaching each bracket plate 12 to the ladder. As shown in FIG. 3, a pair of upper apertures 24a are provided in the bracket plate 12 receive the threaded ends of the upper U-bolt 14a, and a pair of lower apertures 24b in the bracket plate 12 receive the threaded ends of the lower U-bolt 14b. Other holes are provided in the plate for driving mounting screws 20 into a spacer/stabilizer block 18 disposed in the channel of the ladder leg 22 so as not to compromise the structure of the ladder.

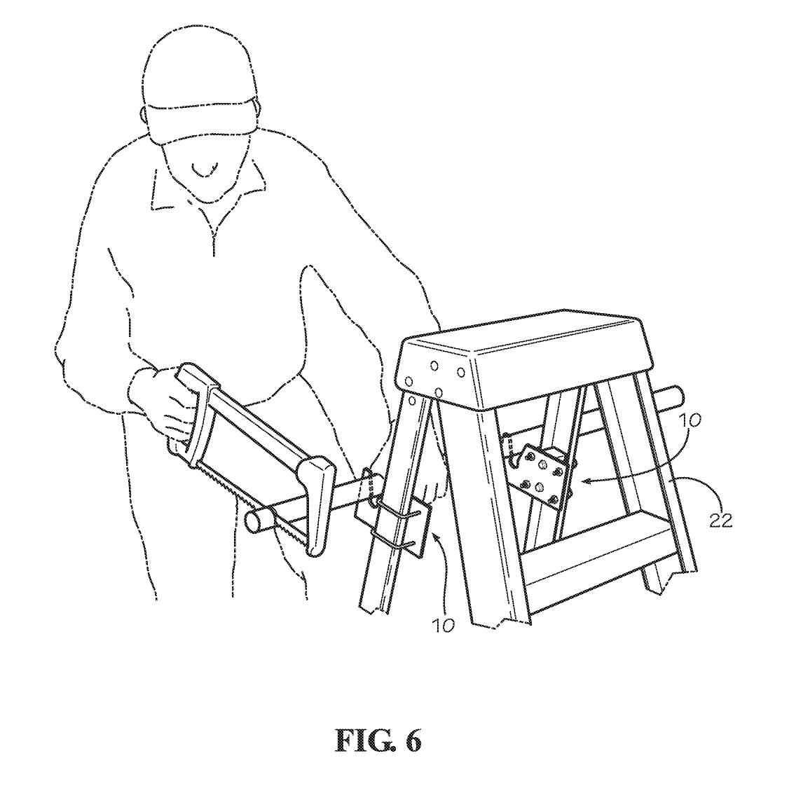

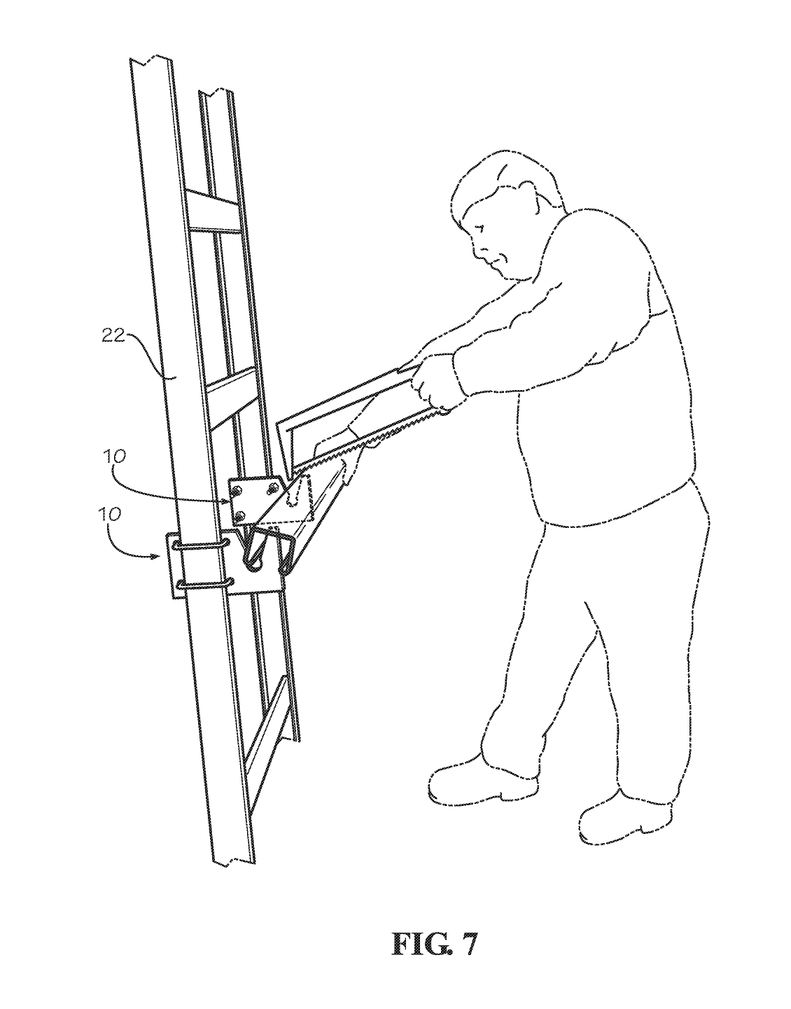

Each bracket plate 12 has a tapered slot 24 extending downward from the upper edge that terminates in a hole 22. The holes 22 in opposing bracket plates 12 attached to a ladder may be used to receive a piece of pipe on which one or more wire spools can be hung as shown in FIG. 5. The holes 22 in opposing bracket plates 12 can also be used for holding a piece of conduit as it is sawed, as shown in FIG. 6. If the pipe to be sawed is too large to be received in the holes, it may be cradled in the tapered slots above the holes.

In a preferred embodiment,
the width WB of the bracket plate is 5½ inches;
the height H of the bracket plate is 3 inches;
the thickness TB of the bracket plate is ⅛ inch;
the distance D between the upper apertures is 2¼ inches;
the distance D between the lower apertures is 2¼ inches;
the upper width Ws of the tapered slot is 1 and ⅜ inches;
the radius R of the hole is ⅜ inch;
the width W_{SB} of the spacer block is 1 and 7/16 inches; and
the thickness TSB of the spacer block is 1¼ inches.

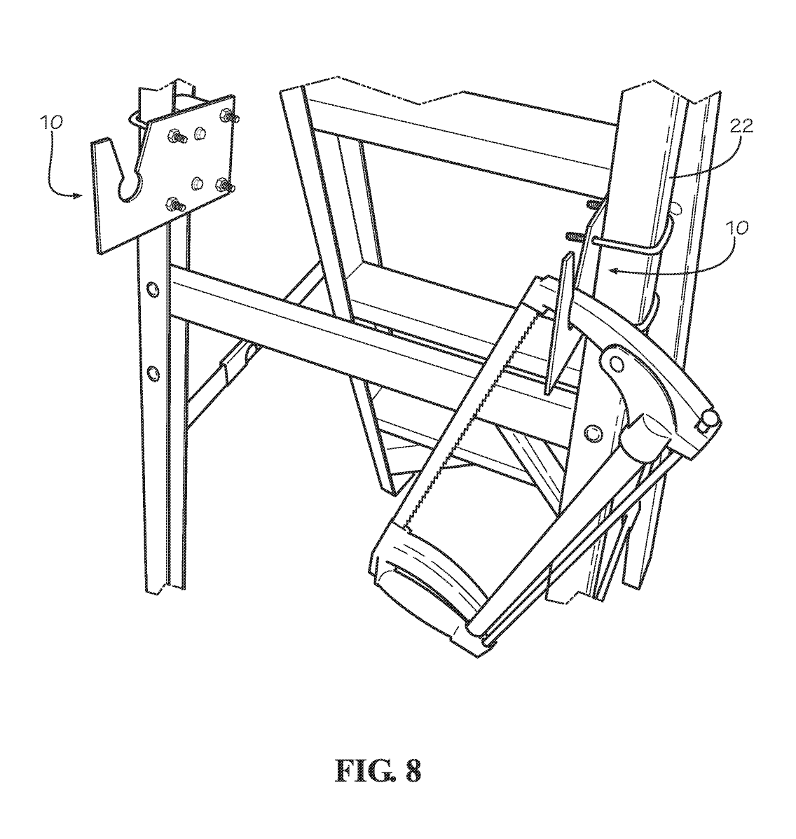

FIG. 7 shows multipurpose ladder attachments 10 being used as a tool for holding a piece of U-channel as it is sawed. FIG. 8 shows one of the multipurpose ladder attachments 10 being used as a hook for holding a hacksaw between cuts, to avoid misplacing the saw.

As shown in FIGS. 4 and 5, the bracket plates 12 of the multipurpose ladder attachments 10 can be mounted toward the outside of the ladder legs (like the pair mounted near the top of the ladder) or toward the inside (like the pair mounted near the bottom of the ladder). By pointing the lower bracket plates 12 inward for supporting additional rolls of wire, it repositions the center of gravity of the ladder and affords more stability. This position also reduces the likelihood of someone bumping into the rolls of wire when walking past the ladder.

When the multipurpose ladder attachments 10 are attached to the ladder, the ladder can still be folded for storage or passing through doorways from room to room.

Also, with the attachments 10 in place, ladders of the same size are still stackable and can be stored one on top of another and can be secured with a chain or cable and locked to prevent theft.

An electrician's ladder with the attachments 10 attached can be easily spotted from across the room, which is very helpful on large construction projects where several contractors may have ladders of the same color type, style and size, which tends to result in ladders being “borrowed” by other trades working on a construction site.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A multipurpose ladder attachment for attaching to a leg of a ladder, the multipurpose ladder attachment comprising;
a bracket plate having an upper edge, a lower edge and a central region disposed between the upper and lower edges, the bracket plate comprising:
a tapered slot extending from the upper edge toward the central region of the bracket plate, the tapered slot having a first width at the upper edge and a second width in the central region, wherein the first width is greater than the second width;
a pair of upper apertures disposed between the upper edge and the central region of the bracket plate, the pair of upper apertures spaced apart from each other by a distance that is greater than a width of the leg of the ladder; and
a pair of lower apertures disposed between the lower edge and the central region of the bracket plate, the pair of lower apertures spaced apart from each other by a distance greater than the width of the leg of the ladder;
an upper U-bolt having ends passing through the pair of upper apertures;
a lower U-bolt having ends passing through the pair of lower apertures;
one or more upper fasteners for attaching to the ends of the upper U-bolt; and
one or more lower fasteners for attaching to the ends of the lower U-bolt,
wherein the upper and lower U-bolts are operable to be disposed around the leg of the ladder, and the upper and lower fasteners are operable to tighten down against the bracket plate to pull the upper and lower U-bolts against the leg of the ladder, thereby securing the multipurpose ladder attachment to the ladder.

2. The multipurpose ladder attachment of claim 1 further comprising a spacer block attached to the bracket plate and disposed between one or both of the pair of upper apertures and the pair of lower apertures, the spacer block operable to be received within an interior portion of the leg of the ladder when the bracket plate is secured to the leg of the ladder.

3. The multipurpose ladder attachment of claim 1 further comprising a circular hole disposed in the central region of the bracket plate and connected to the tapered slot.

4. A multipurpose ladder attachment system for attaching to a ladder, the multipurpose ladder attachment system comprising;
at least two multipurpose ladder attachments attached in tandem to opposing legs of the ladder, each of the multipurpose ladder attachments comprising:
a bracket plate having an upper edge, a lower edge and a central region disposed between the upper and lower edges, the bracket plate comprising:
a tapered slot extending from the upper edge toward the central region of the bracket plate, the tapered slot having a first width at the upper edge and a second width in the central region, wherein the first width is greater than the second width;
a hole disposed in the central region of the bracket plate and connected to the tapered slot;
a pair of upper apertures disposed between the upper edge and the central region of the bracket plate, the pair of upper apertures spaced apart from each other by a distance that is greater than a width of the legs of the ladder; and
a pair of lower apertures disposed between the lower edge and the central region of the bracket plate, the pair of lower apertures spaced apart from each other by a distance greater than the width of the legs of the ladder;
an upper U-bolt having ends passing through the pair of upper apertures;
a lower U-bolt having ends passing through the pair of lower apertures;
one or more upper fasteners for attaching to the ends of the upper U-bolt;
one or more lower fasteners for attaching to the ends of the lower U-bolt; and
wherein the upper and lower U-bolts are operable to be disposed around one of the legs of the ladder, and the upper and lower fasteners are operable to tighten down against the bracket plate to pull the upper and lower U-bolts against one of the legs of the ladder, thereby securing the multipurpose ladder attachment to the ladder,
wherein the tapered slots in the bracket plates of the opposing multipurpose ladder attachments form a cradle in which a section of pipe or conduit may be supported on the ladder, and
wherein the holes in the central region of the bracket plates of the opposing multipurpose ladder attachments are operable to receive a section of pipe or rod on which spools of wire may be supported on the ladder.
